(19) United States
(12) Patent Application Publication
(10) Pub. No.: US 2012/0106146 A1
(43) Pub. Date: May 3, 2012

(54) LED String Lights with Multiple Source Points

(76) Inventor: Cai Jun Hao, Guangdong Province (CN)

(21) Appl. No.: 12/915,050

(22) Filed: Oct. 29, 2010

(51) Int. Cl. F21V 5/00

(52) U.S. Cl. 362/235

(57) ABSTRACT

This invention relates to LED string lights with multiple source points comprising several connected LEDs, wherein each LED is installed on a holder. A solid transparent component is also installed on the holder covering the LED. Inside such solid transparent component, there are many small air bubbles. Lights sent out from the LED get through these bubbles and refraction occurs to form multiple source points. During the production, air shall be blown into the solid transparent component to create many separate air bubbles therein. Lights from the LED get through these air bubbles and refraction occurs. Each air bubble is like a source point. Therefore, it's easy and effective for this invention to create many source points even in one LED.

### BACKGROUND OF THE INVENTION

This invention relates to a light-emitting device, particularly to LED string lights with multiple source points.

In existing technology, a light-emitting device used for decoration comprises a holder, a LED installed on the holder, and a transparent component covering and LED. Several light-emitting devices are connected to form LED string lights which are used to decorate on such objects as trees or walls, or connect two objects. Once electricity is on, the LED string lights will shine or flash, achieving decoration effects. However, the decoration effects are not very good, because there is only one source point in a light-emitting device with one LED. For some other light-emitting device, several small transparent objects are put inside the device. Lights sent out from the LED get through these transparent objects and refraction occurs to form multiple sources points. However, light-emitting device adopting such transparent objects features complicated in production and assembly and expensive in cost due to its small volume.

### BRIEF SUMMARY OF THE INVENTION

The objective of the present invention is to overcome the shortcomings in existing technology and to provide LED string lights with multiple source points, featuring in simple structure to create effects of multiple source points.

To achieve the objective above-mentioned, this invention adopts a technical solution as the following: to create LED string lights with multiple source points comprising several connected LEDs, wherein each LED is installed on a holder. A solid transparent component is also installed on the holder covering the LED. Inside such solid transparent component, there are many small air bubbles. Lights sent out from the LED get through these bubbles and refraction occurs to form multiple source points.

In the LED string lights with multiple source points as set forth, the solid transparent column has a blind hole at the bottom, allowing LED to get into the column; and a flange on the outside of the lower part, connecting to the socket on the holder.

In the LED string lights with multiple source points as set forth, the solid transparent column is a plastic component with a length available between 15 and 100 mm, and a diameter 10 and 30 mm.

This invention enjoys such advantages as the followings: during the production process, air shall be blown into the solid transparent component to create many separate air bubbles therein. Lights from the LED get through these air bubbles and refraction occurs. Each air bubble is like a source point. Therefore, it's easy and effective for this invention to create many source points even in one LED.

### BRIEF DESCRIPTION OF THE DRAWINGS

FIG. 1 is the structure profile of the solid transparent column in Implementation Example One of this LED string lights with multiple source points;

FIG. 2 is the structure profile of the solid transparent ball in Implementation Example Two of this LED string lights with multiple source points;

FIG. 3 is the structure profile of the solid transparent sharp-pointed column in Implementation Example Three of this LED string lights with multiple source points;

### DETAILED DESCRIPTION OF THE INVENTION

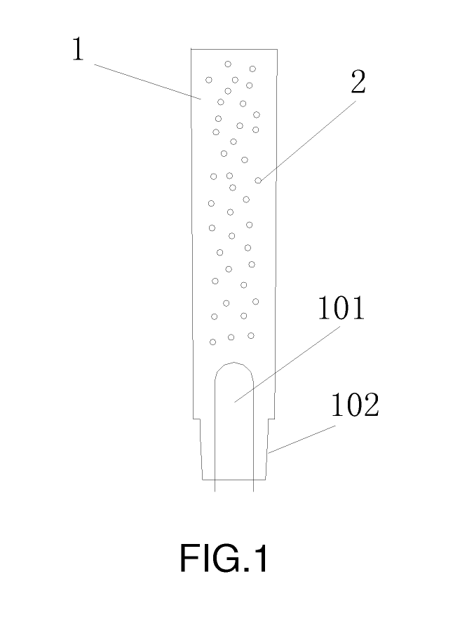

Implementation Example One: as showed in FIG. 1, this invention provides LED string lights with multiple source points comprising several connected LEDs, wherein each LED is in shape of a column. The string lights include a holder (not showed in the figure), and the LED (not showed in the figure) is installed on such holder. A solid transparent component (1) is also installed on the holder covering the LED. Inside such solid transparent component (1), there are many small air bubbles (2). During the production of the solid transparent component (1), air shall be blown into the melting materials to create many air bubbles (2) therein. Lights from the LED get through these air bubbles (2) and create multiple source points.

In the column-shaped light-emitting device with multiple source points as set forth, the solid transparent column (1) has a blind hole (101) at the bottom, allowing LED to get into the column; and a flange (102) on the outside of the lower part, connecting to the socket on the holder. The solid transparent column (1) is a plastic component with a length available between 15 and 100 mm, and a diameter 10 and 30 mm.

In the column-shaped light-emitting device with multiple source points as set forth, the length (B) of the solid transparent column is 35 mm.

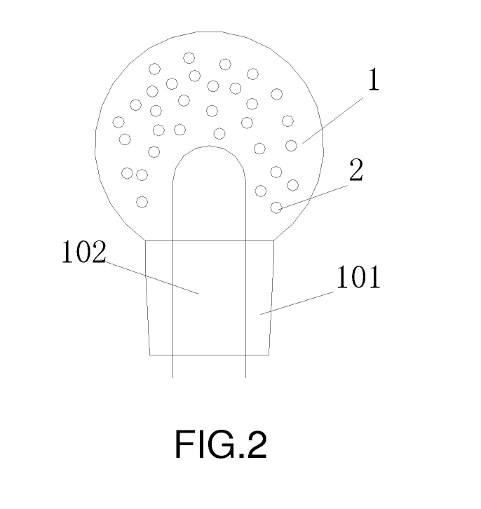

Implementation Example Two: as showed in FIG. 2, this invention provides LED string lights with multiple source points comprising several connected LEDs, wherein each LED is in shape of a ball. The string lights include a holder (not showed in the figure due to limits in existing technology), and the LED (not showed in the figure due to limits in existing technology) is installed on such holder. A solid transparent component (3) is also installed on the holder covering the LED. Inside such solid transparent component (3), there are many small air bubbles (2). During the production process of the solid transparent component (3), special technique is adopted to create many air bubbles (2) therein. Lights from the LED get through these air bubbles (2) and create multiple source points.

In the ball-shaped light-emitting device with multiple source points as set forth, the solid transparent ball (3) has a small outstretched column (301) at the bottom along with a blind hole (302), allowing LED to get into the column. Such blind hole (302) extends to the inside of the solid transparent ball. The solid transparent column is a plastic component with a diameter (B) available between 10 and 30 mm.

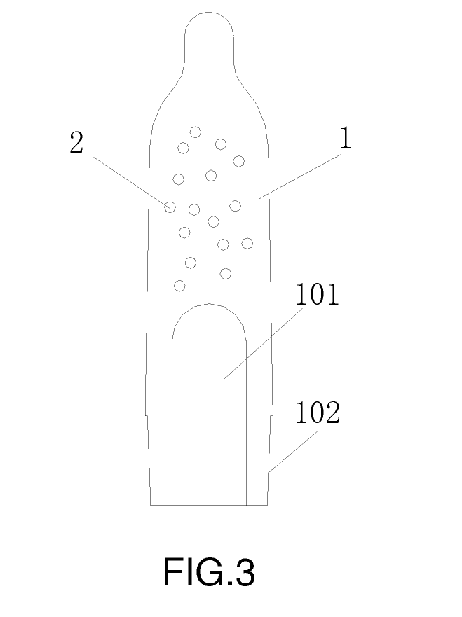

Implementation Example Three: as showed in FIG. 3, this invention provides LED string lights with multiple source points comprising several connected LEDs, wherein each LED is sharp-pointed. The string lights include a holder (not showed in the figure due to limits in existing technology), and the LED (not showed in the figure due to limits in existing technology) is installed on such holder. A sharp-pointed solid transparent component (4) is also installed on the holder covering the LED. Inside such sharp-pointed solid transparent component (4), there are many small air bubbles (2). During the production of the sharp-pointed solid transparent component (4), special technique is adopted to create many air bubbles (2) therein. Lights from the LED get through these air bubbles (2) and create multiple source points.

In the sharp-pointed light-emitting device with multiple source points as set forth, the solid transparent sharp-pointed column has a blind hole (401) on the lower part, allowing LED to get into the column; and a flange (402) on the outside of the lower part, connecting to the socket on the holder. The solid transparent sharp-pointed column is a plastic component with a length (B) available between 15 and 100 mm, and a diameter 10 and 30 mm.

What is claimed is:

1. LED string lights with multiple source points, comprising several connected LEDs, wherein each LED is installed on a holder; a solid transparent component is also installed on the holder covering the LED; inside such solid transparent component, there are many small air bubbles; lights sent out from the LED get through these bubbles and refraction occurs to form multiple source points.

2. LED string lights with multiple source points as set forth in claim 1, characterized in that the solid transparent component covering the LED is a solid transparent column with many air bubbles inside; lights sent out from the LED get through these bubbles and refraction occurs to form multiple source points.

3. LED string lights with multiple source points as set forth in claim 2, characterized in that the solid transparent column has a blind hole at the bottom, allowing LED to get into the column; and a flange on the outside of the lower part, connecting to the socket on the holder.

4. LED string lights with multiple source points as set forth in claim 3, characterized in that the solid transparent column is a plastic component with a length available between 15 and 100 mm, and a diameter 10 and 30 mm.

5. LED string lights with multiple source points as set forth in claim 1, characterized in that the solid transparent component covering the LED is a solid transparent ball with many air bubbles inside; lights sent out from the LED get through these bubbles and refraction occurs to form multiple source points.

6. LED string lights with multiple source points as set forth in claim 5, characterized in that the solid transparent ball has a small outstretched column at the bottom along with a blind hole, allowing LED to get into the column; such blind hole extends to the inside of the solid transparent ball.

7. LED string lights with multiple source points as set forth in claim 6, characterized in that the solid transparent ball is a plastic component with a diameter available between 10 and 30 mm.

8. LED string lights with multiple source points as set forth in claim 1, characterized in that the solid transparent component covering the LED is a solid transparent sharp-pointed column with many air bubbles inside; lights sent out from the LED get through these bubbles and refraction occurs to form multiple source points.

9. LED string lights with multiple source points as set forth in claim 8, characterized in that the solid transparent sharp-pointed column has a flange on the outside of the lower part, connecting to the socket on the holder.

10. LED string lights with multiple source points as set forth in claim 6, characterized in that the pointed solid transparent column is a plastic component with a length available between 15 and 100 mm.
